(19) United States
(12) Patent Application Publication
(10) Pub. No.: US 2004/0189484 A1
(43) Pub. Date: Sep. 30, 2004

(54) COMMUNICATION APPARATUS FOR DEMONSTRATING A NON-AUDIO MESSAGE BY DECODED VIBRATIONS

(76) Inventor: I-Yin Li, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,781

(22) Filed: Mar. 25, 2004

(30) Foreign Application Priority Data
Mar. 27, 2003 (TW) 092107001

(51) Int. Cl. H04Q 1/00

(52) U.S. Cl. 340/825.19; 434/112

(57) ABSTRACT

A communication apparatus, such as a mobile phone, for demonstrating non-audio messages by encoded vibrations. The communication apparatus has an encoding module and a vibrating module. In addition to handling audio communication, the encoding module of the communication apparatus is capable of encoding non-audio messages into a vibration signal, and the vibrating module will vibrate in different patterns according to the vibration signal, such that a user can identify the non-audio messages by tactile sense.

### BACKGROUND OF INVENTION

1. Field of the Invention

The present invention relates to a communication apparatus and more particularly, to a communication apparatus for demonstrating a non-audio message by decoded vibrations.

2. Description of the Prior Art

In this modern information-based society, the well-established wireless mobile communication network has become one of the most popular communicating methods. Through portable mobile phones, users can perform wireless communication or receive service from wireless communication for communicating or exchanging knowledge with other users.

Generally speaking, a basic function of a wireless communication network is providing the wireless transmitting and forwarding services of audio messages. An audio message of a user's speech can be transformed into a radio signal by the user's mobile phone and then transmitted to another user's mobile phone through the bases in the wireless communication network. The radio signal is then converted back into an audio message, so the users on the two sides of the wireless communication network can exchange audio messages and information intuitively.

Besides the basic audio communication services mentioned above, all information companies are actively developing new types of wireless communication services. For example, a user can now input text messages to a mobile phone. The text messages are transformed into a radio signal by the mobile phone and then transmitted to another mobile phone via the wireless communication network. The latter mobile phone converts the radio signal back to the original text message and displays it. Through this kind of wireless communication service, a user may deliver a text message to a plurality of other users in a wireless communication network for exchanging information among users.

A government organization or company can use similar services of text messaging to transmit useful information or data. For example, users can request specific data, such as weather predictions or financial indexes, from a specific service provider through mobile phones. The service provider can then inform users by transmitting the requested data in a text message to the user's mobile phone.

Besides those new services in wireless communication, other additional functions in the mobile phone have been developed. For example, current mobile phones can display the time and store the users address book and working schedule. When the user needs this information, he can operate the mobile phone to display this information. It is convenient for a user to plan a personal schedule or save and load personal information at any time.

However, since non-audio wireless communication services, such as text messaging, and the additional functions of current mobile phones are displayed in text form, the user of the mobile phone must operate or utilize those services or functions with his/her vision. It not only causes the user to lose his concentration but also prohibits visually impaired people from using these services and functions, leading to increased hindrance to those users in operating with network information imperceptibly.

### SUMMARY OF INVENTION

It is therefore a primary objective of the claimed invention to provide a communication apparatus demonstrating a non-audio message by different vibrating patterns to solve the problem mentioned above.

In the prior art technology, wireless communication services, such as short text messages or text data transmitting, and additional functions such as recording by using a mobile phone can only be shown in a text form for display visually. It not only causes a user to lose his concentration but also discourages a visually impaired user from utilizing those services and functions.

It is an advantage of the claimed invention that the present communication apparatus uses an encoding module to encode non-audio messages such as a text data, whereby different encoded results drive the vibrating module to vibrate in different patterns, so the user can recognize the non-audio text message by tactile sense. Therefore, although a user is visually impaired, he can operate non-audio messages and information in such a way that allows him/her to utilize the short text message service or other services in the wireless network conveniently.

The communication apparatus of the present invention can be practiced in a normal mobile phone, so that the mobile phone can not only perform the normal wireless communication services of audio message but also demonstrate the non-audio message through a tactile manner, allowing the mobile phone user to realize an information interface of tactile sense. By using the information interface of tactile sense provided in the present invention, a mobile phone for a visually impaired user can be achieved. In these kinds of mobile phones, the displays for displaying text information such as LCDs can be omitted. Therefore, the manufacturing cost of the mobile phones can be reduced when the function of providing non-audio information service is employed, which results in reducing the handicap of contacting net resources for virtually impaired people.

These and other objectives of the claimed invention will not doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a mobile phone according to an embodiment of the present invention.

FIG. 2 is a schematic diagram of an encoding method of an encoding module in FIG. 1 according to an embodiment of the present invention.

FIG. 3 and FIG. 4 are schematic diagrams of demonstrating the text message, which is encoded by the encoding method shown in FIG. 2, in the mobile phone shown in FIG. 1 according to different vibrating patterns.

FIG. 5 is a perspective view of the mobile phone according to the embodiment in FIG. 1.

### DETAILED DESCRIPTION

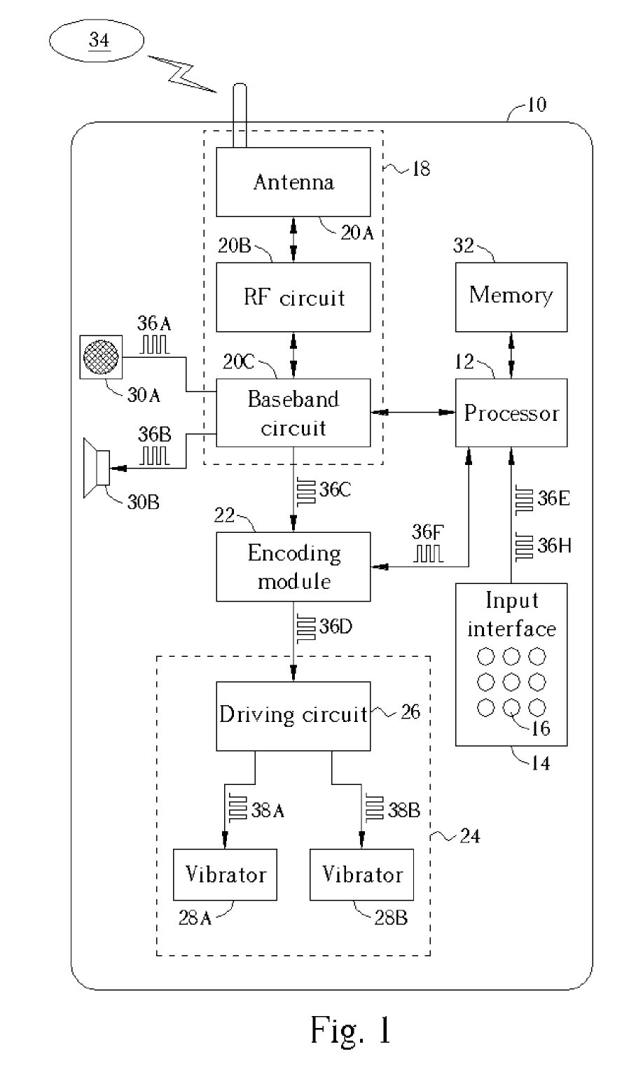

Please refer to FIG. 1, which is a functional block diagram of a mobile phone 10 according to the present invention. The mobile phone 10, which serves as a communication apparatus to operate the wireless network 34, comprises a processor 12, an input interface 14, a communicating module 18, an encoding module 22, a vibrating module 24, a non-volatile memory 32, a microphone 30A, and a speaker 30B. The processor 12 is used to control the operation of the mobile phone 10. The non-volatile memory 32 can be a flash memory using a non-volatile method for storing data such as firmware (used when the processor 12 operates), programs, or other related data such as the users personal data (like a schedule or a communication index).

The input interface 14 comprises a plurality of bottoms 16. When the user presses the different bottoms 16, the input interface 14 generates corresponding control signals 36H and transmits the control signals 36H to the processor 12. Thus, the user can input instructions to the processor 12 to operate the mobile phone 10 via the input interface 14.

The microphone 30A is used to receive a sound wave and transform the sound wave into an audio signal 36A in an electric form. The speaker 30B transforms an audio signal 36B of an electric form into a sound wave and broadcasts the sound wave. The communicating module 18 comprises an antenna 20A, an RF circuit 20B, and a baseband circuit 20C.

The audio signal 36A generated by the microphone 30A is processed by the baseband circuit 20C. Then the audio signal 36A is modulated by the RF circuit 20B to form a high frequency RF signal. Afterwards, the high frequency RF signal is transmitted via the wireless communication network 34 in radio form through the antenna 20A, such as radiating the RF signal to the next base transceiver station in the wireless communication network 34.

Similarly, a radio signal, which is transmitted from the wireless communication network 34 to the mobile phone 10, is received by the antenna 20A and demodulated to a lower frequency signal by the RF circuit 20B. After that, the lower frequency signal is transformed into an audio signal 36b by the baseband circuit 20C and then transformed into a sound wave and broadcasted by the speaker 30B thereby. With the cooperation of the speaker 30B, the microphone 30A, and the communicating module 18, the user of the mobile phone 10 can operate the audio communication service provided by the wireless communication network 34.

In order to accomplish the goal of demonstrating a text message according to vibrating patterns, the mobile phone 10 comprises an encoding module 22 and a vibrating module 24. The encoding module 22 encodes the text message to a corresponding vibrating signal that can be reproduced by the vibrating module 24. Therefore, the user of the mobile phone 10 can recognize the text message provided by the mobile phone 10 via the tactile sense.

To achieve the aforementioned purpose of the present invention, the vibrating module 24 comprises a driving circuit 26 and a plurality of vibrators, which are simplified as 28A and 28B in FIG. 1 for clarity. The driving circuit 26 is used to generate a driving signal 38A to drive the vibrator 28A and a driving signal 38B to drive the vibrator 28B. The vibrators 28A and 28B can perform vibrations in different patterns. For example, the vibrators 28A and 28B can vibrate with different frequencies lower than the sound wave, such as a frequency less than 200 Hz, or vibrate with different amplitudes.

As mentioned above, the text message demonstrated by the mobile phone may be a short text message from a wireless communication network or text data provided by an additional function of the mobile phone. The radio short text message from the wireless communication network 34 is received by the antenna 20A, demodulated by the RF circuit 20B, and processed by the baseband circuit 20C to form a text signal 36C which is then transmitted to the encoding module 22. Similarly, by using the processor 12 to access data in the memory 32 and operate the related programs properly, the text data demonstrated by the mobile phone 10 due to the additional functions of the mobile phone 10 is transformed into a text signal 36F, which is also transmitted to the encoding module 22 from the processor.

According to the text signals 36C and 36F, the encoding module 22 generates a corresponding vibrating signal 36D to the driving circuit 26. Using the vibrating signal 36D, the driving circuit 26 drives the vibrators 28A and 28B with corresponding driving signals 38A and 38B. Vibrators 28A and 28B then vibrate in different patterns in order to represent different text messages.

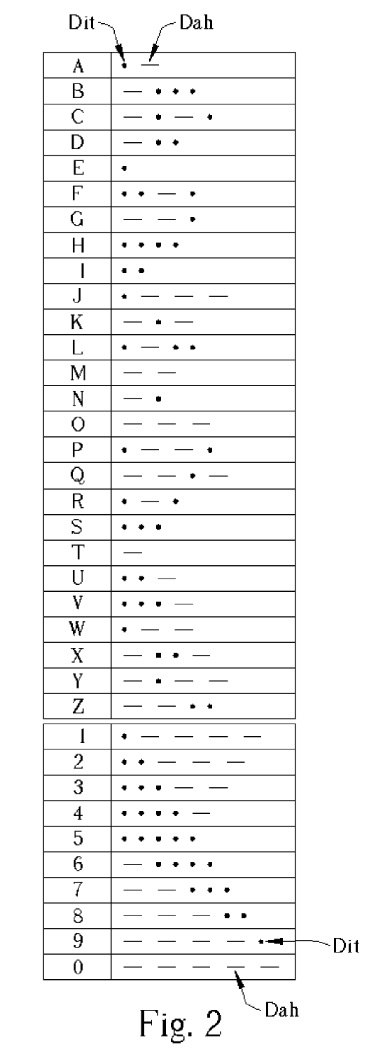

To describe the method of using different vibrating patterns to represent different text messages of the present invention in detail, a specific encoding method is disclosed in following. Please refer to FIG. 2. In the present invention, the commonly used international standard—Morse code—can be used to encode different text messages with two different characters. FIG. 2 shows the corresponding codes for different letters.

In Morse code, different letters can be represented by using two Morse code characters—Dit and Dah—arranged in different orders. For example, the English letter “A” is denoted by a Dit followed by a Dah. The three characters Dah, Dit, Dit arranged in that order represent the English letter “D”. The four characters Dah, Dah, Dit, Dit arranged in that order represent the English letter “Z”. In the same manner, numbers can be also denoted by the characters with different orders. As shown in FIG. 2, the five characters Dit, Dah, Dah, Dah, Dah in that order represent the number “1”. The characters Dah, Dah, Dah, Dah, Dah in that order represent the number “0”. Certainly, punctuation symbols are also defined in Morse code but are not described here since it does not affect the disclosure of the present invention.

By using Morse code, the encoding module 22 can present the text message with two different characters. Thus, the driving module 24 can use the two vibrating patterns of vibrators 28A and 28B to represent those two characters. Users can tactilely sense the order of different vibrating patterns to obtain the order of the characters and then know the letters according to the order of the characters.

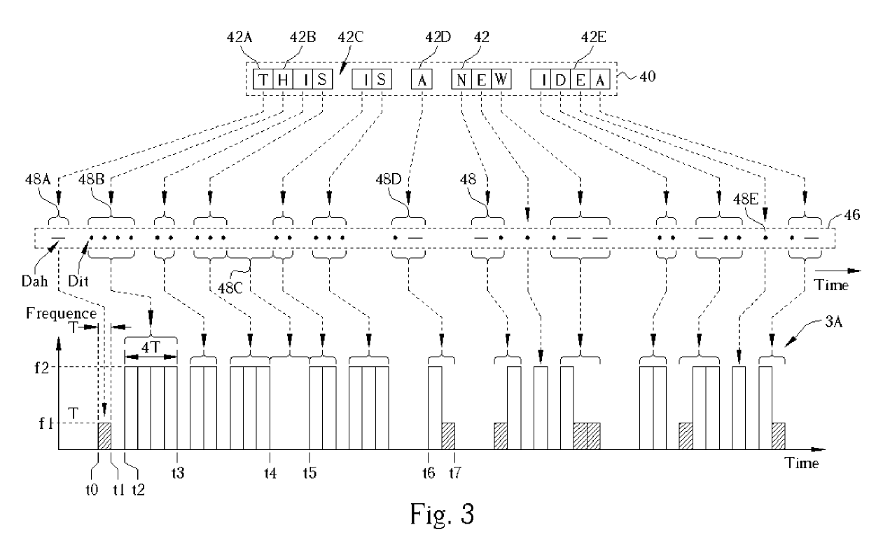

FIG. 3 shows a schematic diagram of demonstrating a text signal 40 with different vibrating patterns in Morse code according to the present invention. The horizontal axis in FIG. 3 is time. As shown in FIG. 3, the demonstrated text signal 40, which can be either the text signal 36C or 36F in FIG. 1, is “THIS IS A NEW IDEA” in sequence. Each of the letters in the text signal 40 including the separation between the letters is treated as a text data 42. For ease of description, several letters are sub-tagged as text data 42A to 42E for illustration.

The encoding module 22 can encode the text data 42 in the text signal 40 into corresponding vibrating data 48, which is sub-tagged as 48A to 48E for clarity, in a vibrating signal 46 according to the Morse code shown in FIG. 2. For example, the letter “T” of the text data 42A is encoded as the character Dah in the vibrating data 48A. The letter “H” of the text data 42B is encoded as the characters “Dit, Dit, Dit, Dit” in the vibrating data 48B. The separation between the letters in the communicating data 42 can be represented by a specific time duration of a rest as shown by the vibrating data 48C in FIG. 3. In the same manner, the letter “A” of the communicating data 42D is encoded as the characters “Dit, Dah” in the vibrating data 48D. The letter “E” of the communicating data 42E is encoded as the character “Dit” in the vibrating data 48E according to the definition shown in FIG. 2.

After the text signal 40 is encoded into the vibrating signal 46, the driving circuit 26 can drive the vibrators 28A and 28B to demonstrate different characters Dit and Dah by different vibrating patterns. For example, the vibrators 28A can perform a vibration with a frequency f1, such as 2 Hz, and the vibrators 28B can perform a vibration with a frequency f2, such as 10 Hz. The vibrator 28A performs the vibration with the frequency f1 for a constant time duration T, such as 0.5 second, to represent the character Dah. In the same manner, the vibrator 28B performs the vibration with the frequency f2 for a constant time duration T to represent the character Dit. Integrating the overall vibrating patterns of the vibrators 28A and 28B in the vibrating module 24, the content of the text signal 40 can be demonstrated.

Please refer to FIG. 3A in FIG. 3, which is a schematic diagram of the overall vibrating patterns of the vibrating module 24 versus time. The horizontal axis of FIG. 3A is time and the vertical is frequency. As shown in FIG. 3A, in an interval between the time t0 and t1, a vibration with a frequency f1 and lasting for a time duration T is used to represent the vibrating data 48A, which is the letter “T” in the text data 42A. In an interval between the time t2 and t3, a vibration with a frequency f2 and lasting for a time duration 4T is used to represent the four Dit characters in the vibrating data 48B. In an interval between the time t4 and t5, a rest or no vibration is used to represent the text data 42C, which means there is a separation between letters. In an interval between the time t6 and t7, a vibration with a frequency f1 lasting a time duration T and a frequency f2 lasting a time duration T is used to represent the vibrating data 48D, which corresponds to the letter “A” of the text data 42D.

Besides using vibrations with different frequencies, the vibrating module 24 can also perform vibrations differently in other ways for demonstrating different characters. For example, the vibrators 28A and 28B can perform vibrations with different amplitudes. The character Dah is demonstrated by performing a vibration with a smaller amplitude for a time duration T, and the character Dit is demonstrated by performing a vibration with a larger amplitude for a time duration T. The characters Dah and Dit can be also demonstrated by performing vibrations with the same amplitude and frequency but of different time durations. As a result, the user of the communication apparatus can distinguish different vibrating data according to this invention.

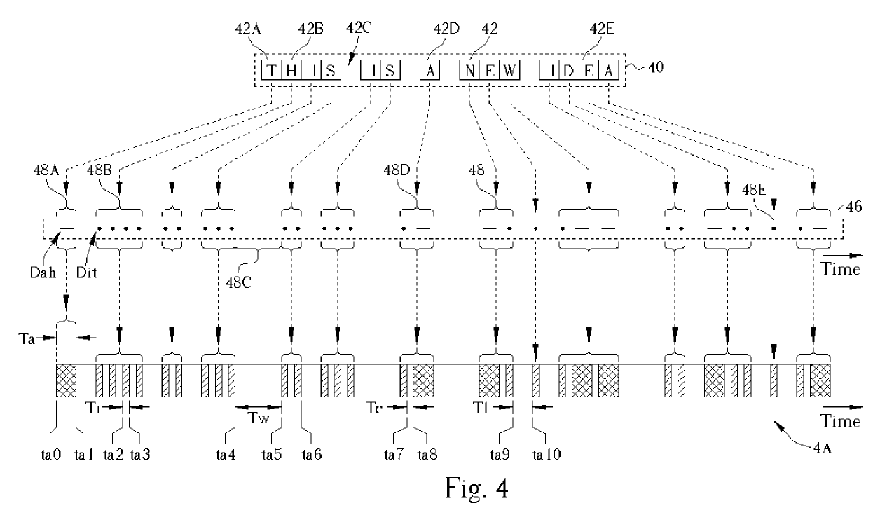

Please refer to FIG. 4, which is a schematic diagram of demonstrating different text messages by performing vibrations with different vibrating patterns according to another embodiment of the present invention. The text message “THIS IS A NEW IDEA” in the test signal 40, which is the same as that shown in FIG. 3, is demonstrated by different vibrating patterns in FIG. 4. As shown in the additional FIG. 4A of FIG. 4, in which the horizontal axis is time, a vibration with a time duration Ta is treated as the character Dah in the vibrating signal 46 and a vibration with a time duration Ti is regarded as the character Dit.

The twill region and a meshed region distributed along the time axis in FIG. 4A show the time of the vibration generated by the vibrating module 24. For example, the meshed region between the time ta0 and ta1 means that the vibrating module 24 performs a vibration lasting a time duration Ta for demonstrating the character Dah in the vibrating signal 46. The twill region between the time ta2 and ta3 means that the vibrating module 24 performs a vibration lasting a time duration Ti for demonstrating the character Dit.

The blank region in FIG. 4A means the rest time of the vibrating module 24. For example, the vibration can be stopped for a time duration Tc between the two characters that are used to form the same letter. Such a rest lasting for a time duration Tc is used to distinguish the characters Dit and Dah in the vibrating data 48D in the interval between the time ta7 and ta8.

In the same manner, the interval between the time ta9 and ta10, the vibrating module 24 stops vibration for a time duration T1 to separate the letter “N” and “E” in the word “NEW” in the text signal 40. In addition, among words, the vibration can be stopped for a time duration Tw to separate different words. For example, in the interval between the time ta4 and ta5, the vibrating module 24 can stop vibration for a time duration Tw to demonstrate the separation among words in the text signal 40, which is the text data 42C used to separate the words “THIS” and “IS”.

Certainly, the embodiment in FIG. 4 can be combined with the embodiment in FIG. 3. For example, in FIG. 4, a vibration with a frequency f1 and a time duration Ta can be used to demonstrate the character Dah in the vibrating signal 46, a vibration with a frequency f2, and a time duration Ti can be used to demonstrate the character Dit. Moreover, a vibration with a specific amplitude and a time duration Ta is used as the character Dah, and a vibration with another specific amplitude and a time duration Ti is used as the character Dit.

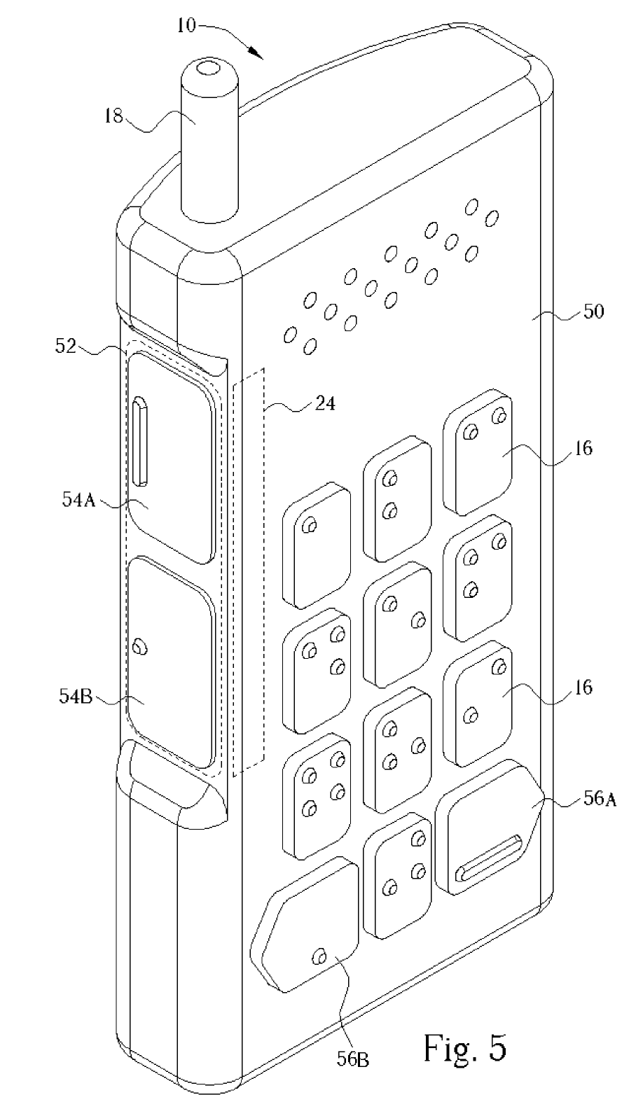

Please refer to FIG. 5, which is a perspective diagram of the mobile phone 10 according to the embodiment of the present invention. As shown in FIG. 1 and FIG. 5, the mobile phone 10 comprises an outward surrounding housing 50 and buttons 16 as an input interface 14 to input commands or data into the mobile phone 10 by users. In order to achieve the purpose of the present invention that is to demonstrate text signals by vibrating patterns, a sense area 52 is disposed on the housing 10. The vibrating module 24 is positioned under the sense area 52 so that the vibration can be spread to the sense area 52 easily and users can sense the vibration from the vibrating module 24 via the sense area 52.

Besides the aforementioned methods, which perform vibrations in different patterns by differing the frequencies, amplitudes, and time durations, the present invention can also perform vibrations in different patterns by differing vibration positions to demonstrate different text signals. For example, the sense area 52 comprises two sub-sense areas 54A and 54B for spreading the vibration of vibrators 28A and 28B respectively. The embodiment of the present invention shown in FIG. 4 can also utilize the vibrator 28A to vibrate for a time duration Ta in the sub-sense area 54A to mean the character Dah in the vibrating signal and use the vibrator 28B to vibrate for a time duration Ti in the sub-sense area 54B to mean the character Dit in the vibrating signal. It is also obvious that the vibrations in different sub-sense areas can be performed with different vibrating frequencies and amplitudes in the same manner as described in the embodiments of FIG. 3 and FIG. 4.

In addition, the input interface 14 can be combined with the vibrating module 24 so as to have both the functions of receiving the input from the user and performing vibrations in different patterns to demonstrate text signals. For example, two buttons 56A and 56B are disposed on the housing 50 for inputting commands or text signals. The button 56A can be used as the character Dah, and the button 56B can be used as the character Dit.

When the user wants to transmit a short text message to another mobile phone, he can press the buttons 56A and 56B to input text messages. The text messages are then transformed into a communication data 36E by the input interface 14 and encoded to a text signal by the processor 12 or the encoding module 22. The text signal is then transmitted to the communicating module 18 and delivered in radio form.

The vibrators 28A and 28B of the vibrating module 24 can be disposed near the buttons 56A and 56B so the vibrations generated by the vibrators 28A and 28B can be transmitted to the buttons 56A and 56B. When the mobile phone 10 wants to demonstrate a text message, the buttons 56A and 56B can vibrate in different patterns to demonstrate the text message. For example, the button 56A vibrates for demonstrating the character Dah and the button 56B vibrates for demonstrating the character Dit. As a result, the user can deliver and receive the text message through the same interface.

As previously mentioned, the present invention is applied to a mobile phone designed for a visually impaired user. As shown in FIG. 5, each of the buttons 16, 56A, and 56B has an extruded structure or a recessed structure to indicate to the user the function and meaning of each buttons. The mobile phone 10 in the present invention also omits the display used in the common mobile phone for demonstrating information through vision. Thus, the cost of the mobile phone 10 can be reduced effectively. Furthermore, the present invention can deliver the text messages to users and reduce the handicap for a visually impaired user in accessing a wireless network source. This makes the life of visually impaired users more convenient.

In the present invention, the encoding module 22 shown in FIG. 1 may be an independent hardware circuit, a specific firmware, or a program executed by the processor 12 to achieve the function of encoding text messages 36C into the vibrating signal 36D. In addition, the present invention can be applied to a pager or any other information receiving apparatuses, which are usually used to receive information from a wireless network only, and the delivering functions thereof are omitted. For example, pagers are usually used to receive and display text messages. The information receiving apparatuses are used to receive information provided by specific information service providers, such as a financial index.

The spirit of the present invention can also be realized in these kinds of apparatuses by demonstrating text messages with different vibrating patterns. Though only two vibrators 28A and 28B are shown in the embodiment of FIG. 1, the present invention can also demonstrate text messages by using only one vibrator if the single vibrator can perform vibrations in different patterns. In this case, only one vibrator is required in the vibrating module 24.

Moreover, though Morse code is illustrated in the embodiments in FIGS. 2, 3 and 4, the present invention can use other coding methods to demonstrate different text messages by different vibrating patterns.

Additionally, a plurality of coding methods can be built in the mobile phones with the selection of the coding method being determined by the user. The related parameters in different vibrating patterns can be set by the user. For example, in the embodiment of FIG. 4, each of the time durations Ta of the character Dah, the time duration Ti of the character Dit, and other parameters can have a predetermined value which is built-in by the manufacturers initially but capable of being manually adjusted by the user.

Currently, the mobile phone has a function of notifying users of an incoming call through vibrations. The present invention is surely capable of realizing the same function of incoming phone notification with a specific vibrating pattern of the vibrating module 24 or an additional vibrator excluded by the vibrating module 24.

In the prior art technology, no matter if the short text message is provided by the wireless communicating network or the additional functions of a mobile phone, a visional interface, such as a display, is necessary for presentation to users. In comparison with the prior art, the present invention demonstrates encoded text messages by vibrating in different patterns so as to realize a tactile interface between the user and mobile phone for text messages, and more particularly, a communicating apparatus designed for the visually impaired people.

Those skilled in the art will readily observe that numerous modifications and alterations of the invention may be made while retaining the teachings of the invention. Accordingly, the above disclosure should be construed as limited only by the metes and bounds of appended claims.

What is claimed is:

1. A communication apparatus comprising:
an encoding module for encoding a text message into a vibration signal, the text message comprising a plurality of text data, each of the text data respectively encoded into a corresponding vibration data of the vibration signal by the encoding module; and
a vibrating module electrically connected to the encoding module for vibrating correspondingly according to the vibration data of the vibration signal in sequence.

2. The communication apparatus of claim 1 wherein the communication apparatus further comprises a communicating module electrically connected to the encoding module for receiving the text message from a communication network.

3. The communication apparatus of claim 1 wherein the vibration of the vibrating module has a vibration frequency less than a frequency of a sound wave.

4. The communication apparatus of claim 1 wherein the vibrating module comprises a vibrator that is capable of vibrating in different frequencies for vibration.

5. The communication apparatus of claim 1 wherein the vibrating module comprises a plurality of vibrators, whereby different vibrators vibrating in different frequencies.

6. The communication apparatus of claim 5 wherein the vibrators are disposed in different positions of the communication apparatus.

7. The communication apparatus of claim 1 wherein the vibrating module performs vibrations in different time durations to distinguish different vibrating data.

8. The communication apparatus of claim 1 wherein when the vibrating module performs vibrations in different amplitudes of vibrations to distinguish different vibrating data.

9. The communication apparatus of claim 2 wherein the communicating module is used to receive a radio signal.

10. The communication apparatus of claim 9 wherein the communication apparatus is a mobile phone.

11. The communication apparatus of claim 2 wherein the communication apparatus further comprises an input interface for receiving instructions input from a user and generating a corresponding text signal which is transmitted to the communicating module afterward.

12. The communication apparatus of claim 2 wherein the communication apparatus further comprises:
a microphone for transforming sound waves to an electric audio signal; and
a speaker electrically connected to the communicating module for transforming an electric sound signal to a sound wave and broadcasting the sound wave;
wherein the communicating module is capable of transmitting the audio signal to the communication network and receiving the sound signal.
